(19) United States
(12) Patent Application Publication
(10) Pub. No.: US 2010/0236969 A1
(43) Pub. Date: Sep. 23, 2010

(54) Poly(Lactic Acid) and Zeolite Composites and Method of Manufacturing the Same

(75) Inventors: Rafael Auras, Lansing, MI (US); Susan Selke, East Lansing, MI (US); Isinay E. Yuzay, East Lansing, MI (US)

Correspondence Address: HOWARD & HOWARD ATTORNEYS PLLC, 450 West Fourth Street, Royal Oak, MI, 48067, US

(73) Assignee: BOARD OF TRUSTEES OF MICHIGAN STATE UNIVERSITY, East Lansing, MI (US)

(21) Appl. No.: 12/726,094

(22) Filed: Mar. 17, 2010

Related U.S. Application Data
(60) Provisional application No. 61/161,566, filed on Mar. 19, 2009.

(51) Int. Cl. B65D 85/00; B01J 29/04; C08G 63/06

(52) U.S. Cl. 206/524.6; 502/62; 528/361

(57) ABSTRACT

A composite material and method of forming the same which is useful in a variety of applications, including modified atmosphere packaging, that involves the preparation and characterization of solid, that is, without void spaces, polylactide (PLA) composites containing nanoporous zeolites, among other things.

### BACKGROUND OF THE INVENTION

1. Field of the Invention

The present invention relates generally to films and containers, and more particular, to composites formed from polymeric materials comprising biopolyesters, such as poly(lactic acid), commonly referred to as polylactide (PLA), and zeolite, and systems and methods for manufacturing the same.

2. Description of the Related Art

An increased awareness of environmental issues is driving the need to use biodegradable polymers. Polylactide (PLA) is one of the most widely-used biodegradable plastic alternatives to traditional petroleum based packaging plastics. PLA can be derived from renewable resources such as corn and sugar beets and can be composted under certain temperature and humidity conditions. The production of PLA also requires less energy and produces less carbon dioxide than does that of traditional packaging polymers.

To date, incorporation of zeolites into a PLA matrix for packaging applications has not been utilized. Zeolites have been used with various polymers, such as polydimethylsiloxane (PDMS) polyethersulfone (PES), polyimide, polyaniline (PANI), low-density polyethylene (LDPE), high-density polyethylene (HDPE), polypropylene (PP), polyvinyl alcohol (PVOH), polyvinyl acetate (PVAc), ethylene vinyl acetate (EVAc), polystyrene (PS), cellulose acetate (CA), and polycarbonate (PC) for gas and liquid separation purposes. In these applications, large amounts (up to 40-50 wt %) of zeolite were added to the polymer systems. Zeolites are also used in active packaging applications formed from non-PLA, particularly for fresh produce and vegetables with high respiration rates. Further, some of these known applications require that the surface of the zeolites be treated for better dispersion in the polymer matrix for improved properties, which increases the cost and resources to manufacture the same.

### SUMMARY OF THE INVENTION

The invention is generally directed to polymeric composites containing zeolites and methods of making the same, wherein the polymeric portions have characteristics which create a substantially non-permeable barrier without voids substantially surrounding the zeolites, and applications therefore, including packages or containers incorporating such composite materials.

In some embodiments, the polymeric material used in composites of the invention include poly(lactic acid) or polylactide (PLA).

In some embodiments, the composite material includes a substrate constructed of a polymeric material and zeolite disposed in the substrate, wherein the substrate material is substantially non-permeable and the percentage of zeolite by weight may range from about 0% to about 10%. The polymeric material may be PLA and in some embodiments the percentage zeolite by weight comprises about 0% to about 7%, or about 5%, or about 3% or less. The zeolite may be substantially homogenously embedded in the substrate material.

In other embodiments, the invention is directed to packaging systems which provide a storage space having features capable of affecting atmospheric conditions therein. The packaging system may consist of a body having interior walls including a bottom and sidewalls defining a cavity of storage space therein, wherein at least a portion of the interior walls includes a polymeric composite comprising a substantially non-permeable substrate and zeolite disposed therein. In some embodiments, the percentage of zeolite by weight ranges from about 0% to about 10%, while in others the percentage range is between about 0% to about 7%, or about 0% to about 5%, or less. In some embodiments, the polymeric composite with zeolite may disposed as a film on a portion of the interior walls, while in other embodiments the polymeric composite comprises at least a portion of an interior wall.

In some embodiments, the zeolite selected has a pore size of about 3.8 to about 4 Å.

In some embodiments, the PLA/zeolite composites of the invention were successfully fabricated using extrusion followed by injection and compression molding processes. The PLA/zeolite composites formed according to some embodiments of the subject invention and the morphological, mechanical, and barrier aspects of the composites indicate their usefulness in many applications. The morphological studies showed a homogenous distribution of zeolites in the PLA matrix. As the stress propagated through the composites, zeolite particles remained embedded into the matrix, indicating the existence of good interfacial adhesion between zeolite particles and the PLA matrix, among other things. The percent crystallinity of the PLA increased with the proportion of zeolites while no significant changes occurred in the glass transition, melting and heat deflection temperatures. With addition of about 5 wt % zeolite, the storage modulus, loss modulus and damping (tan δ) were enhanced. The modulus of elasticity was also positively correlated with zeolite content while the elongation at break was reduced with increasing zeolite loading. The permeability results showed a low value of CO₂/O₂ permselectivity for the PLA/zeolite composites, which is a distinct advantage in certain applications.

The PLA composite exhibits useful physical, mechanical, thermal, and barrier properties when compared with non-zeolite containing composites. These properties were illustrated using a wide range of analytical techniques including: scanning electron microscopy (SEM), transmission electron microscopy (TEM), atomic force microscopy (AFM), x-ray diffraction (XRD), differential scanning calorimetry (DSC), and dynamic mechanical analysis (DMA). SEM and TEM studies showed a homogeneous distribution of zeolites in the PLA matrix. DSC thermograms of the composites indicated the percent crystallinity of the PLA increased with the amount of zeolites while no significant changes occurred in the glass transition and melting temperatures. The modulus of elasticity was enhanced in the presence of zeolite content, while the elongation at break was reduced with increasing zeolite loading. The effects of temperature on mechanical properties were also studied using DMA. The permeability characteristics of PLA/zeolite composites were studied and compared with those of commercially available zeolite filled films made with petroleum based polymers. Another advantageous application of the subject invention includes using such PLA and zeolite composite films as liners for other containers. For example, as a liner to a cardboard box that contains food stuff.

Further, the amount and/or type of zeolite can be used in some embodiments of the invention to manipulate the desired properties of the composites, such as the permeability ratio of select gases for example. The zeolite may also aid in removal or adsorption of off-flavors and odors for items stored in the composites, among other things. Therefore, inclusion of zeolite is capable of enhancing PLA's existing advantages such as breathability and compostability while making it multi-functional as well.

### BRIEF DESCRIPTION OF THE DRAWINGS

Other advantages of the invention will be readily appreciated as the same becomes better understood by reference to the following detailed description when considered in connection with the accompanying drawings wherein:

FIG. 1 are X-ray diffraction patterns for injection molded specimens formed from neat PLA and specimens formed from PLA with 1, 3, and 5 wt % zeolite loadings;

FIG. 2 is a graph illustrating the effects of zeolite loading on tensile properties of PLA/zeolite composites; and

FIG. 3 is a graph illustrating temperature dependence of storage modulus, loss modulus, and damping (tan δ) of PLA/zeolite composites of a specimen formed from neat PLA and a specimen formed from PLA with 5 wt % zeolite.

### DETAILED DESCRIPTION OF THE INVENTION

The subject invention provides, among other things, polymeric materials containing zeolites formed into a composite material. In some embodiments, the composite material of the invention have been found to be particularly useful when formed as films. The films may be standalone films for use in further applications or integrated or incorporated with containers, such as an interior liner.

Suitable polymeric materials to be used in this invention include, but are not limited to biodegradable aliphatic and aliphatic-aromatic polyesters, for example, poly(lactic acid) (PLA), poly (caprolactone) (PCL), poly(trimethylene terephthalate) (PTT) polyhydroxyalkanoates (PHAs), including poly(hydroxybutyrate) (PHB), poly(hydroxybutyrate-valerate) (PHBV) and copolymers thereof; poly(butylene adipate-co-terephthalate) (PBAT), aliphatic-aromatic co-polyesters such as 1,4-butylene terephthalate-co-adipate sold under the tradename Ecoflex® by BASF; sulfonated aliphatic-aromatic copolyesters such as Biomax® manufactured by DuPont, or derivatives and combinations of the foregoing polymers. PLA is discussed further herein as a non-limiting example which is well suited for formation as a composite according to some embodiments of the invention.

The PLA composite may be formed with compositions of lactide, either L- or D-lactide. In the exemplary embodiments discussed herein, specimens formed according to the subject invention were formed from polylactide (approx. 94% L-lactide) resin samples provided by NatureWorks® LLC (Minnetonka, Minn.). It is to be appreciated that various other PLA compositions may be used with the subject invention. A suitable polylactide is available as 4042 D from Natureworks® LLC.

Various types of zeolites may be used in the embodiments of the subject invention. For example, the zeolite may be selected from either synthetic zeolites or natural zeolites, or varying combinations thereof. In some embodiments, the selection of zeolite may at least partially depend on particular criteria or characteristics of the zeolite component itself. For instance, the average pore size of the zeolite or the shape/configuration of the zeolite may be considered for particular applications.

One example of zeolites used include type 4A synthetic zeolite with a pore size of 3.8-4 Å. The framework is generally cubic in shape and includes sodium cations therein. Examples of natural zeolite are chabazite and clinoptilolite. The other synthetic and natural zeolites that have been listed by the Structure Commission of the International Zeolite Association (IZA-SC), which is herein incorporated by reference, could also be used with the subject invention. Zeolite type 4A can be obtained from UOP LLC (Des Plaines, Ill.) in the form of powder.

In some embodiments, the PLA composites of the invention are formed containing about 0 to about 5 wt % zeolite using a mini twin-screw extruder through an injection molding technique. In this technique, PLA resin pellets and zeolite powders were first dried in a vacuum oven at 60° C. for 3 hrs and at 100° C. for 24 hrs, respectively. Next, PLA pellets were dry mixed with zeolite powders in various ratios depending upon the amount of zeolite loading desired. Finally, the resulting mixture was fed into a micro-compounding machine (DSM Research, The Netherlands) equipped with co-rotating twin screws having lengths of 150 mm, L/D ratio of 18, and capacity of 15 cm³. After a certain cycle time, the PLA/zeolite extrudates were transferred into the injection molder by a pre-heated transfer cylinder.

Various kinds of specimens such as tensile dog-bone specimens, XRD disks, Izod, and DMA bars were prepared using the injection molder. The extruder and injection molder process conditions were optimized to enable production of high quality composite samples. One preferred set of operating conditions for the extruder is a temperature profile of 190° C., 190° C., 190° C., a screw speed of 100 RPM, and a cycle time of about 5 minutes. The preferred conditions for the injection molder were a pressure of about 130 psi, a mold temperature of 30° C., and a residence time of about 15 sec. It is to be appreciated that other conditions may be desired depending upon the type of PLA and zeolite.

Injection molded XRD disks were also used to produce composite film samples. One disk was placed between 2 metal plates covered with Teflon sheets and then inserted into a hydraulic press (Hydraulic Unit model #3925, Carver Laboratory Equipment, Wabash, Ind., US). The press jaws were set to 190° C. The metal plates were left in the press without any pressure for 2 minutes to allow the PLA composite disk to melt. Then, a compression pressure of about 70 psi was applied for 3 minutes in order to obtain thin film samples. Finally, samples were cooled for 15 minutes at room temperature.

The transparency of injection molded and compression molded PLA and PLA/zeolite composites were compared. While remaining transparent, the relative transparency was found to be reduced generally as the wt % of zeolite increased in neat PLA, 1, 3 and 5 wt % of zeolite samples. Compression molded PLA/zeolite films show relative transparency of the composite films of the invention also reduced based upon the amount of zeolite present in the specimens.

High resolution images were obtained to determine the size, shape, and distribution of zeolites in the PLA matrix of the composite material. Morphological analyses were done by a scanning electron microscope SEM JSM 6400 (JOEL, Japan) on the izod impact tested fracture surfaces of PLA and PLA/zeolite composites. The fractured surfaces were sputter coated with a ˜15 nm layer of gold prior to test. An accelerating voltage of 15 kV was used to collect SEM images.

The nano scale structure of PLA/zeolite composites was investigated using TEM. The TEM bright field images were taken using a JEOL 100CX (Joel, Calif.) at an acceleration voltage of 150 kV. First, PLA/zeolite composite samples (the middle part of tensile dog-bone specimens) were ultramicrotomed with a diamond knife at room temperature to give 70 nm thick sections and then the sections floating on distilled water were transferred to carbon coated copper grids of 300 mesh. Due to the high electron density differences between zeolites and the PLA matrix, heavy-metal staining of sections was not applied.

SEM studies showed a homogenous distribution of zeolite particles in the PLA matrix. As the fracture stress propagated through the composites, zeolite particles remained embedded into the matrix. Zeolite particles exhibited a cubical shape in the composites of the invention with an average particle size ranging from 700-1000 nm.

The surface topography of neat PLA and PLA/zeolite samples was also examined using AFM. The AFM measurements were done with a Nanoscope IIIA (Digital Instruments, Santa Barbara, Calif.) operating in contact mode, at ambient conditions. Images of 30×30 μm were scanned on two different locations of each sample. The root-mean-squared (RMS) roughness calculations were performed by NanoScope software (Digital Instruments, Santa Barbara, Calif.).

The images of 30×30 μm were scanned on two different locations of each sample. It was found that neat PLA and PLA/zeolite composite films of the invention have similar surface topographies. Values of the roughness parameter (RMS) were derived from the AFM data. The neat PLA and PLA with 5 wt % zeolite exhibited roughness values from 77 to 144 nm and 58 to 246 nm, respectively.

XRD was also used to characterize PLA and PLA/zeolite composites. Samples were examined using an X-ray diffractometer (Rigaku 200B) operated at a voltage of 45 kV and a current of 100 mA, equipped with Cu Kα radiation source (λ=1.541 nm). Each scan was recorded from 2θ: 2 to 35° with a step width of 0.02° and a step time of 0.4 s at room temperature.

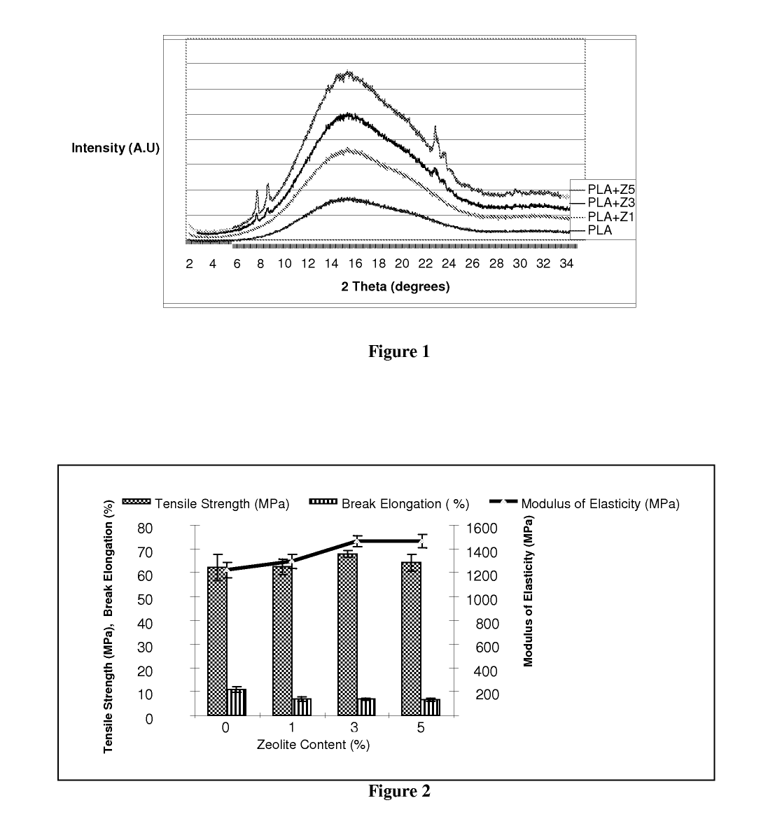

X-ray diffraction patterns for the injection molded neat PLA and PLA/zeolite composites are presented in FIG. 1. The broad peak observed at approximately 2θ=15-16° suggests that the injection molded neat PLA samples have predominantly an amorphous structure. After inclusion of 3 and 5 wt % zeolites into the PLA matrix, four narrow sharp peaks were detected at 2θ=7.84, 8.78, 22.96, and 23.82° as the diffraction peaks of zeolites in the composites which indicates the crystalline nature of zeolites.

The thermal analyses of PLA/zeolite composites were performed on a DSC Q100 (TA Instruments, NewCastle, Del.) in accordance with ASTM D3418-03. The samples were equilibrated at 25° C. and heated to 180° C. at a heating rate of 10° C./min under continuous nitrogen flow. For each sample, the glass transition temperature (T_{g}), cold crystallization temperature (T_{cc}), melting temperature (Tₘ), and enthalpies of cold crystallization (ΔH_{c}) and melting (ΔHₘ) were determined from the thermogram. The degree of crystallinity (X_{c}) of the PLA and PLA/zeolite composites was evaluated according to the following equation:

$${X}_{c} ( \% ) = \frac{( Δ {H}_{m} - Δ {H}_{c} )}{Δ {H}_{f} ( 1 - x )} * 100 \qquad ( 1 )$$

where ΔH_{f} is the enthalpy of fusion of 100% crystalline PLA which is cited in the literature as 917 μg. The x is the weight fraction of zeolite in the composite.

The heat deflection temperature (HDT) was measured by a DMA Q800 (TA Instruments, NewCastle, Del.) operating in the three-point bending mode according to ASTM D 648. The specimens used for this analysis were rectangular bars of average size 2.00 mm×12.00 mm×58.00 mm (thickness×width×length). The specimens were heated at the rate of 2° C./min from room temperature to 80° C. under a constant load of 455 kPa and the HDT was determined as the temperature at which the specimens reached 0.2% strain.

Tensile properties, such as modulus of elasticity, tensile strength, and elongation at break, of PLA/zeolite composites containing 0, 1, 3, and 5 wt % zeolite were measured in accordance with ASTM D 638-03 using an Instron tensile testing system (Instron 5565 Canton, Mass.). Five dog-bone specimens were tested for each composite and the mean values were reported.

The temperature dependence of storage modulus and loss modulus of PLA/zeolite composites was also evaluated using DMAQ800 (TA Instruments, NewCastle, Del.). The test was carried out by heating the samples at a rate of 2° C./min from room temperature to 90° C. The samples were tested in a dual cantilever mode at an oscillating amplitude of 15 μm and frequency of 1 Hz.

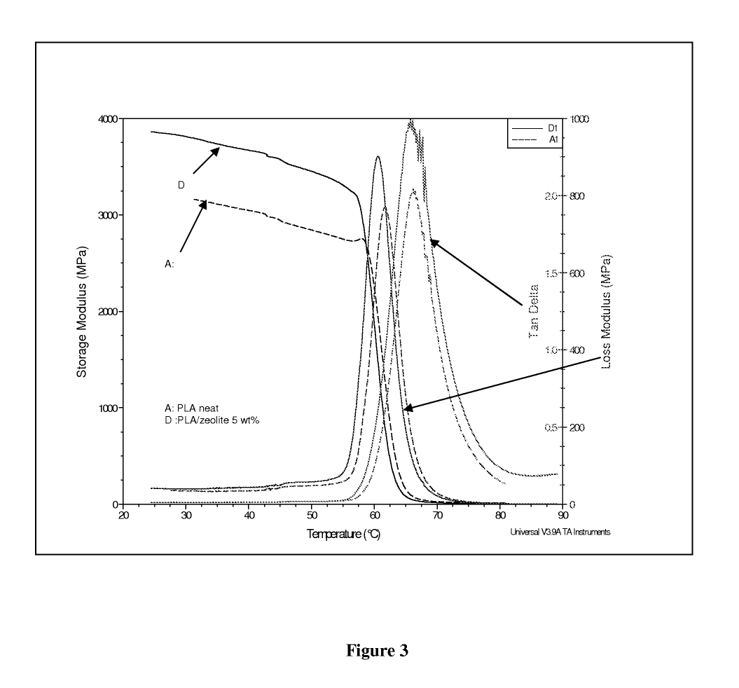

FIG. 2 displays the tensile properties of PLA and PLA/zeolite composites. With increasing zeolite loading, tensile strength of the composites did not decrease while the modulus of elasticity increased, which can be evidence of good adhesion between PLA and zeolite particles. A typical graph of temperature dependency of storage modulus, loss modulus, and damping factor, tan δ, for neat PLA and PLA/zeolite composites is shown in FIG. 3. The storage modulus of PLA with 5 wt % zeolite was also found to be higher than that of neat PLA at 30° C. A similar trend was also observed at higher temperatures such as 50° C. The graph of tan δ indicates that the tan δ peak was much higher and broader for PLA with 5 wt % zeolite composites compared with neat PLA, indicating PLA/zeolite composites have better damping properties.

The effects of zeolite content on thermal transition temperatures, heat of fusion values, and percent crystallinity of PLA were determined by DSC. As can be seen from Table 1, there were no significant changes in the glass transition and melting temperatures of the composites; however, the cold crystallization temperature shifted from 123.6±4.0 to 114.3±1.6° C. with addition of 5 wt % zeolite. This would indicate that zeolite particles might act as nucleating agents in the PLA matrix. Although the percent crystallinity of neat PLA samples was 3.2±0.7%, the samples with zeolite had higher crystallinity values (7.6±1.2%). There was also a good correlation between DSC and XRD results.

TABLE 1
Thermal transition temperatures and percent crystallinity of PLA and
PLA/zeolite composites; as determined by differential scanning
calorimetry (DSC)^{N1}

| Zeo- | | | | | |
|---|---|---|---|---|---|
| lite | | | | | |
| con- | | | | | |
| tent | | | Tₘ (° C.) | | |
| wt % | T_{g} (° C.) | T_{cc} (° C.) | Tₘ₁ | Tₘ₂ | X_{c} (%) |
| 0 | 58.5 ± 0.7 | 123.6 ± 4.0 | 148.0 ± 3.7 | 153.8 ± 0.7 | 3.2 ± 0.7 |
| 1 | 57.9 ± 1.7 | 119.0 ± 1.2 | 149.9 ± 0.8 | 153.9 ± 1.1 | 5.2 ± 1.1 |
| 3 | 57.5 ± 1.5 | 116.7 ± 3.4 | 149.1 ± 1.6 | 154.7 ± 2.2 | 6.2 ± 2.2 |
| 5 | 58.7 ± 1.7 | 114.3 ± 1.6 | 148.0 ± 1.4 | 155.0 ± 1.2 | 7.6 ± 1.2 |

^{N1}Mean ± standard deviation

The HDT of the neat PLA was found to be 54.7° C. The 3-point bending test showed that the HDT value of PLA was not much affected by the presence of zeolites.

The water vapor transmission rate (WVTR) was measured using a Permatran W3/33 from Mocon Inc. (Minneapolis, Minn.) in accordance with ASTM F 1249-06. Temperature and relative humidity of the test were 37.8° C. and 90% RH, respectively. The oxygen transmission rate (OTR) was tested using an Illinois 8001 (Illinois Instruments, Ill.) in accordance with ASTM D 3985-02. Test conditions: 23° C., 0% RH. Carbon dioxide transmission rate (CO₂ TR) was also measured using a Permatran C 4/41 from Mocon Inc. (Minneapolis, Minn.) according to ASTM F 2476-05. Temperature and relative humidity of the test were 23° C. and 0% RH, respectively.

The results of water vapor, oxygen, carbon dioxide permeability measurements and the ratio of CO₂/O₂ permeability (i.e., permselectivity) of PLA, PLA/zeolite and commercially available zeolite filled film (i.e., non-PLA film) (Evert-fresh Green Produce Bags from Evert-Fresh Corp, Houston, Tex.) are shown in Table 2. Incorporation of 5 wt % zeolites into the PLA matrix exhibited higher water vapor, oxygen, and carbon dioxide permeability values than that of neat PLA. The permselectivity (CO₂/O₂) for the PLA/zeolite composite was found to be 0.16, implying their potential suitability for modified atmosphere packaging systems, among other things. In these systems, the O₂ consumption rate and CO₂ production rates are preferably in balance with the O₂ and CO₂ permeability of the packaging films. In general, polymer films used for food packaging have a ratio of CO₂/O₂ permeability approximately 4-8:1. In many cases, this ratio is not very favorable because it allows CO₂ permeation at higher rates than O₂. Therefore, PLA/zeolite composites can be used for altering the CO₂/O₂ permselectivity of the modified atmosphere packaging systems.

TABLE 2
Gas permeability values obtained from neat PLA, PLA/zeolite
composite films and commercially available mineral containing film.

| | Permeability | | | |
|---|---|---|---|---|
| | Water vapor | Oxygen | Carbon dioxide | Perm- |
| | [g · mil/m² · | [cc · mil/ | [cc · mil/ | selectivity |
| | day · atm] | m² · day · atm] | m² · day · atm] | α_{CO2/O2} |
| PLA | 553 ± 122 | 1444 ± 335 | 3590 ± 230 | ~2.48 |
| PLA + 5 | 656 ± 118 | 67728 ± 6750 | 11366 ± 920 | ~0.16 |
| wt zeolite | | | | |
| Evert-fresh | 23.5 ± 1.7 | 24433 ± 8427 | 28385 ± 3220 | ~1.16 |

It is noted that the polymeric/zeolite composite material of the invention is constructed without void spaces for fluid flow therein. Zeolites are typically crystalline porous nanostructures with pore sizes ranging from about 3 to 15 Å. In general, the structure of zeolites consists of SiO₄ and AlO₄ tetrahedra, which form a network of channels and cavities. While the polymeric substrate material is substantially non-permeable without voids for fluid flow, the distinctive pore structure of zeolites is used to trap different types of transition metal ions, gases, and liquids, such as, but not limited to, CO₂, O₂, N₂, CH₄, H₂S, NH₃, VOCs, and odorous compounds therein.

It is contemplated that functional implementation of the PLA composites of the invention described herein may include applications as films in packaging systems for perishable items, such as produce, or integration or otherwise incorporation with the support body or walls of a container for holding perishables. Furthermore, PLA composites of the invention may be included as separate inserts for use in packaging systems. It should be readily apparent that there are a variety of uses for the composite materials of the invention other than as a packaging system for perishable goods.

Obviously, many modifications and variations of the invention are possible in light of the above teachings. It is to be understood that the disclosed methods and compositions may be incorporated in a variety of applications. The foregoing described embodiments of the invention are provided as illustrations and descriptions. They are not intended to limit the invention to the precise forms described herein. It is to be understood that modifications and variations may be utilized without departure from the spirit and scope of the invention and method disclosed herein, as those skilled in the art will readily understand. Such modifications and variations are considered to be within the purview and scope of the appended claims and their equivalents.

1. A composite material, comprising:
a) a substrate constructed of a polymeric material; and
b) zeolite disposed in the substrate,
wherein the substrate material is substantially non-permeable and the percentage of zeolite by weight may range from about 0% to about 10%.

2. A composite material as recited in claim 1, wherein the polymeric material is PLA.

3. A composite material as recited in claim 1, wherein the percentage zeolite by weight comprises about 0% to about 5%.

4. A composite material as recited in claim 1, wherein the zeolite is substantially homogenously embedded in the substrate material.

5. A packaging system providing a storage space with features capable of affecting atmospheric conditions therein, comprising a body having interior walls including a bottom and sidewalls defining a cavity of storage space therein, wherein at least a portion of the interior walls includes a polymeric composite comprising a substantially non-permeable substrate and zeolite disposed therein, wherein the percentage of zeolite by weight may range from about 0% to about 10%.

6. A packaging system as recited in claim 5, wherein the zeolite is disposed as a film on a portion of the interior walls.

7. A packaging system as recited in claim 5, wherein the polymeric composite comprises a portion of the interior walls.

8. A packaging system as recited in claim 5, wherein the polymeric composite includes PLA.

9. A packaging system as recited in claim 5, wherein the percentage of zeolite by weight ranges from about 0% to about 5%.

10. A packaging system as recited in claim 5, wherein the zeolite has a pore size of about 3.8 to about 4 Å.
